(19) United States
(12) Patent Application Publication
(10) Pub. No.: US 2003/0097408 A1
(43) Pub. Date: May 22, 2003

(54) Communication method for message information based on network

(76) Inventors: Masahiro Kageyama, Hino (JP); Tomokazu Murakami, Tokyo (JP); Hisao Tanabe, Hachioji (JP); Junichi Kimura, Koganei (JP); Youichi Horii, Kokubunji (JP); Yoshihiro Yamada, Tokyo (JP); Akio Shibata, Higashimatsuyama (JP)

Correspondence Address: Mattingly, Stanger & Malur, P.C., Suite 370, 1800 Diagonal Road, Alexandria, VA, 22314, US

(21) Appl. No.: 10/083,356

(22) Filed: Feb. 27, 2002

(30) Foreign Application Priority Data
Nov. 19, 2001 (JP) 2001-352535

(51) Int. Cl. G06F 15/16; G09G 5/00

(52) U.S. Cl. 709/205; 345/758

(57) ABSTRACT

The invention provides an information exchange method allowing for the following: when watching a TV program or the like, a plurality of terminal users in remote locations exchange information, simultaneously watching a visual object displayed on the TV receiver screen, wherein visual information and messages such as chat are linked up. Assuming that two or more terminal devices connect to a computer network and information about content of interest rendered by media is communicated over the network, information to identify the content, target area selected to define a part or all of an object from the content, and messages are sent and received between or across two or more terminals via the computer network.

### BACKGROUND OF THE INVENTION

The present invention relates to an information exchange system via a network and, more particularly, to a method of information exchange through chat sessions in which content of interest rendered by media is shared across a plurality of end users, and terminal devices and a server equipment for information exchange as well as a computer program of such method.

A diversity of information is shared and exchanged across people over computer networks such as the Internet. For example, information existing on servers interconnected by the Internet is linked together by means called hyperlinks and a virtually huge information database system called the World Wide Web (WWW) is built. In general, Web sites/pages including a home page as a beginning file are built on the network, which are regarded as units of information accessible. On the Web pages, text, sound, and images are linked up by means of a hypertext-scripting language called HTML (Hyper Text Markup Language). On the servers, an information exchange system called “Bulletin Board System (BBS)”, an electronic bulletin board system, and the like is run. This system enables end users to exchange information, using their terminals such as personal computers (PCs) connected to the Internet in a manner that users connect to a server, submit a message written for a specific subject to the bulletin board, and the message is registered on the bulletin board.

Meanwhile, PC users interconnected by the Internet communicate text information one another through chat sessions, using software called “Instant Messenger” on their terminals. A so-called “chat room” on-line service (a virtual space on the network) allows two or more people in remote locations to have conversations in real time over the network, thereby exchanging information.

### SUMMARY OF THE INVENTION

When watching a TV program or video content distributed over the Internet or the like, if an end user (audience) takes interest in, for example, an actor appearing in a drama program or the scene of the location of a drama, and wants to ask or tell someone else of the matter of interest over the network, the user would have to access a BBS and submit a subject and a message to the bulletin board in the conventional method.

This is true even if other Web devices such as chat rooms for information exchange service using the Internet are used. With the existing devices, such a communication manner is impossible that visual objects and other data are linked up; that is, pointing at visual information such as an object image on the TV, while exchanging information about the object. Before chatseekers who take interest in the same subject initiate a chat session, they must execute a complex procedure including search by specifying a keyword and looking for a BBS or the like where information is exchanged about the subject of interest.

In order to easily implement information exchange as described above, an object of the present invention is to provide a new information exchange method by which a session is easy to initiate across chatseekers taking interest in the same subject and information about the same subject of interest can easily be exchanged, and terminal devices and a server equipment for information exchange as well as a computer program of such method.

The present invention provides a new information exchange method by which a subject of interest such as a visual object is directly linked with messages and a method of grouping people who take interest in the same visual object.

In accordance with the present invention, a terminal device for information exchange allows its user to link a visual object with message by easy operation. An information exchange server equipment of the present invention allows for easy information exchange between or across the terminal devices for information exchange. Furthermore, the server equipment is able to make up a client group of a plurality of terminals so that one terminal can transmit information to another terminal in the group.

To solve the above-noted problem and in accordance with a first aspect of the present invention, assuming that terminal devices for information exchange (hereinafter referred to as terminals) connect to a computer network and information about content of interest rendered by media is communicated over the network, an information exchange method for exchanging information between or across two or more terminals is provided. In this information exchange method, information to identify the content and target area selected to define a part or all of an object from the content are sent and received between or across two or more terminals.

In another aspect of the invention, an information exchange method is provided in which a first terminal receives or retrieves content of interest rendered by media and sends information to identify the content, target area selected to define a part or all of an object from the content, and a message to a second terminal across the computer network, and the second terminal receives and records or retrieves content of interest rendered by media, outputs the information to identify the content that it received and a frame from the content including the object defined by the target area selected, and outputs the message that it received.

In yet another aspect of the invention, an information exchange server equipment is provided comprising means for receiving and storing information to identify the content, target area selected, and messages transmitted across the computer network from terminals into a database; means for making up a group of one or more terminals, according to a predetermined grouping method using the information to identify the content and the target area selected; and means for transmitting the information to identify the content, the target area selected, and the messages over the computer network.

In a further aspect of the invention, a computer executable program is provided comprising the steps of inputting and displaying content of interest rendered by media; obtaining information to identify the content; obtaining target area selected to define a part or all of an object from the content; inputting messages; and transmitting and receiving the information to identify the content, the target area selected, and messages over a computer network.

In a still further aspect of the invention, a program is provided for causing a computer to execute the steps of receiving and storing information to identify the content, target area selected, and messages transmitted from terminals into storage; making up a group of one or more terminals, according to a predetermined grouping method using the information to identify the content and the target area selected; and transmitting the information to identify the content, the target area selected, and the messages over the computer network.

These and other objects, features and advantages of the present invention will become more apparent in view of the following detailed description of the preferred embodiments in conjunction with accompanying drawings.

### BRIEF DESCRIPTION OF THE DRAWINGS

FIG. 1 is a conceptual drawing of a first preferred embodiment of the present invention.

FIG. 2 is a process explanatory drawing of one example of the information exchange method in accordance with the present invention.

FIG. 3 is a process explanatory drawing of another example of the information exchange method in accordance with the present invention.

FIG. 4 is a process explanatory drawing of an example of the method of grouping terminals in accordance with the present invention.

FIG. 5 shows an exemplary configuration of a terminal in the present invention.

FIG. 6 illustrates an example of displaying content on the display of a terminal in the present invention.

FIG. 7 illustrates another example of displaying content on the display of a terminal in the present invention.

FIG. 8 illustrates yet another example of displaying content on the display of a terminal in the present invention.

FIG. 9 is a conceptual drawing of a further preferred embodiment of the present invention.

FIG. 10 is a process explanatory drawing of a further example of the information exchange method in accordance with the present invention.

FIG. 11 is a conceptual drawing of exemplary thumbnail generating means in the present invention.

FIG. 12 is a conceptual drawing of a still further preferred embodiment in which the present invention is applied to an education system.

### DESCRIPTION OF THE PREFERRED EMBODIMENTS

Preferred embodiments of the present invention will now be described hereinafter with reference to the accompanying drawings.

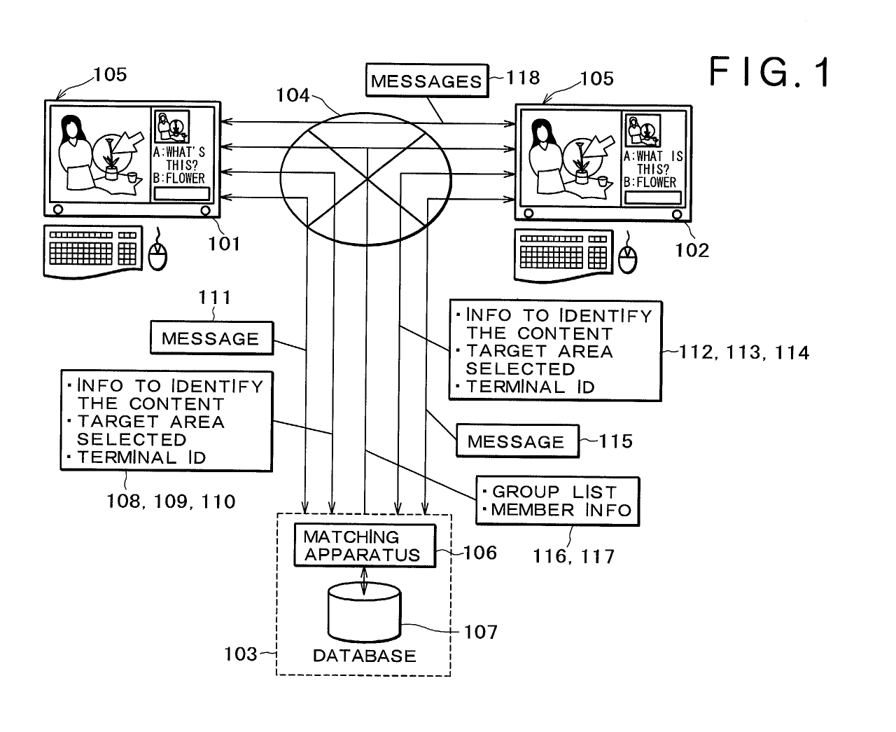

FIG. 1 is a conceptual drawing of a first preferred embodiment of the present invention. This drawing represents an information exchange system in which two terminal devices for information exchange (hereinafter referred to as terminals), terminal A 101 and terminal B 102 connect to an information exchange server equipment (hereinafter referred to as a server) 103 via a computer network (hereinafter referred to as a network) 104, wherein chat sessions between the terminals take place for exchanging information including text, sound and video. The network assumed herein may be either a common network such as the Internet or a network for providing a communication channel of mobile telephone or the like and does not depend on a specific protocol.

Same content of interest rendered by media 105 is input to the terminals A 101 and B 102. The content of interest 105 may be any distinguishable one for both terminals independently (that is, it is distinguishable from another content rendered by media), including a video image from a TV broadcast, packaged video content from a video title available in CD, DVD, or any other medium, streaming video content or an image from a Web site/page distributed over the Internet or the like, and a video image of a scene whose location and direction are identified by a Global Positioning System (GPS). The server comprises a matching apparatus 106 and a database 107. The server receives information specifics transmitted from the terminals, stores them into the database 107, and groups a plurality of terminals together, using the matching apparatus 106 so that the terminals can communicate with each other. The grouping method will be explained later. Each terminal sends information to identify the content 108, 112, target area selected 109, 113, its terminal identifier 110, 114 such as its address, and a message 111, 115 to the server and receives a group list 116 and information (hereinafter referred to as member information) 117 for the users of the terminals belonging to the group (hereinafter referred to as members) from the server. The terminals may exchange messages 118, information to identify the content, and target area selected each other by peer-to-peer communication. The information specifics will be explained later.

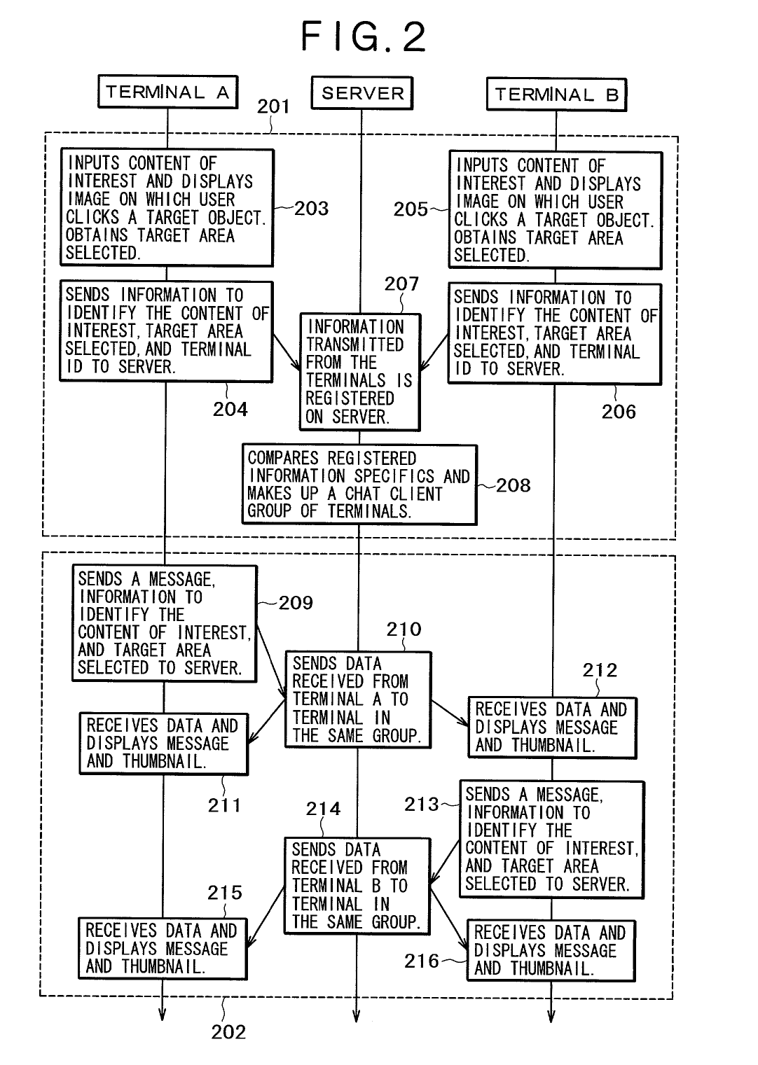

Using FIG. 2, a method of information exchange in accordance with the present invention will be explained below.

The method of information exchange between terminal A 101 and terminal B 102 through the server 103 is divided into two phases: step 201 in which the server makes up a chat client group of terminals and step 202 in which the terminals exchange information each other through a chat session. First, the step 201 will now be explained.

In steps 203, 205, same content of interest rendered by media 105 is input to terminal A 101 and terminal B 102. Using an illustrative case where the content of interest is the one rendered by TV broadcasting, these steps will be detailed below. At the terminal A 101, the content of interest is reproduced and displayed in the step 203. When the operating user of terminal A takes interest in an object on the reproduced video image, the user defines the position and area of the object on the displayed image with a coordinates pointing device (such as a mouse, tablet, pen, remote controller, etc.) included in the terminal A. By way of example, as shown in FIG. 1, the user clicks on a flower in a vase displayed on the screen and defines the position and area of the flower on the display screen. At this time, terminal A first obtains information to identify the content of interest input to it (hereinafter referred to as information to identify the content). As the information to identify the content, for example, the broadcast channel number over which the content was broadcasted, receiving area (in the case of local TV broadcasting), etc. may be used in the case of TV broadcasting. For otherwise obtained content such as packaged video content from a video title available in DVD or the like or streaming video content, information unique to the content (for example, ID, management number, URL (Uniform Resource Locator), etc.) may be used. Terminal A also obtains time information as to when the content of interest was acquired and information to identify the target position and area within the displayed image (hereinafter referred to as target area selected) from the time at which the object was clicked and the defined position and area of the object. As for the time information, the time when the content was broadcasted may be used for the content rendered by TV broadcasting. For the packaged video or streaming video content, time elapsed relative to the beginning of the title may be used. The time information assumed herein comprises year, month, day, hours, minutes, seconds, frame number, etc. The time may be given as a range from the time at which the acquisition of the content starts to the time of its termination measured in units of time (for example, seconds). As the target position/area within the displayed image, area shape specification (for example, circle, rectangle, etc.), parameters, and the like may be used (if the area shape is a circle, the coordinates of its central point and radius are specified; if it is a rectangle, its baricentric coordinates and vertical and horizontal edge lengths are specified). When the above time range and target area information is generated, either time range or target position/area within the displayed image may be specified rather than specifying both time range and target position/area or the whole display image from the content may be specified. For the use of peer-to-peer communication between terminals, terminal identifiers are also specified. As the terminal identifier, for example, address information such as IP (Internet Protocol) address, MAC (Media Access Control) address, and e-mail address assigned to the terminal, a telephone number if the terminal is a mobile phone or the like, and user identifying information if the terminal is uniquely identifiable from user information (name, handle name, etc.) may be used. Peer-to-peer communication between terminals will be explained later.

In step 204, terminal A 101 then sends the information to identify the content of interest 108, target area selected 109, and its terminal identifier 110 to the server 103.

At the terminal B 102, on the other hand, in step 205 corresponding to the step 203 for terminal A 101, the content of interest is input and displayed, and the user selects area of an object in which the user takes interest on the displayed image. Thereby, the terminal obtains information to identify the content of interest 112, target area selected 113, and its terminal identifier 114. In step 206 corresponding to the step 204, terminal B sends the information to identify the content of interest 112, target area selected 113, and its terminal identifier 114 to the server 103.

In step 207, then, the server 103 receives both sets of information to identify the content of interest, target area selected, and address information transmitted from terminal A 101 and terminal B 102 and registers them into the database 107. The server stores the terminals' identifiers into the database and manages them so that the terminals can be grouped together. During this process, the server may assign discrete IDs applied within it to the terminals.

In step 208, the server 103 then compares the registered information specifics and makes up a chat client group of terminals, using the matching apparatus 106. With reference to the illustrative example of FIG. 1, the matching apparatus compares the information to identify the content 108 and target area selected 109 received from terminal A 101 and the information to identify the content 112 and target area selected 113 received from terminal B 102, and determines whether to makes up terminal A and terminal B into a chat client group. For example, if there is a match between both of information to identify the content received from terminal A 101 and terminal B 102 and both target areas selected overlap to some extent, the terminals A and B are grouped so that they can initiate a chat session. Specifically, assume that, watching a same program of TV broadcast, the user of terminal A 101 and the user of terminal B 102 each selected area by clicking an object on the display, wherein both areas are relatively close (in the example of FIG. 1, the area including the same flower image). Then, the server 103 determines that the same object was selected at terminal A 101 and terminal B 102, makes up a chat client group of these terminals, registers the terminals A 101 and B 102, and makes the terminals interconnect. By using this method, means for allowing two or more people who were interested in and selected the same object in an intuitive manner without using search means such as keywords to initiate a chat session can be provided. Details on determination methods will be described later. Member information may be transmitted to all terminals or a limited number of terminals belonging to a group. Member information will be described later.

In the above-described process of step 201, terminal A 101 and terminal B 102 can thus be grouped together. The number of terminals to be grouped together is not limited to two; three or more terminals may be grouped together.

Then, step 202 in which the terminals in the same group (group 1) exchange chat messages each other through a chat session will be explained. Step 202 represents a manner in which chat messages are exchanged via the server.

A manner in which terminal A 101 sends messages to terminal B 102 belonging to group 1 will first be described.

In step 209, terminal A 101 sends a message 111 together with the information to identify the content 108 and target area selected 109 to the server 103. This is equivalent to sending information such as text, sound, and video to be exchanged through a chat session. The user of terminal A creates text and other information, using an input device such as a keyboard, and sends the thus created information as the message via the server to chat clients expected to have a chat with the user. The message may include text, a string of characters representing a keyword, user information, advertising information, time information, thumbnail images, a track of pointer move, user voice, and images captured by a camera. Text may include symbols and icons as acceptable in general chat services. As the user information, user name, nickname (handle name), mail address, URL of the user's Web site home page, etc. may be transmitted. Such a manner is also possible that the user information is registered on the server 103 in advance and it is sent to chat client terminals when the server receives the user ID. The advertising information may include images, text, and the like for advertisement prepared by the advertiser. Images and text for advertisement may be added to the message at the sender terminal or the server. As the time information, the time when the chat message was issued or the time when the target object was clicked may be transmitted. A thumbnail of the image displayed from the content of interest on which the object was clicked may be transmitted. To enable a chat client terminal to reproduce the pointer move, the track of the pointer move may be transmitted. Pointer move tracking will be explained later. The information to identify the content 108 and target area selected 109 may be transmitted. The above-recited information specifics are sent via the server to other terminals in the chat client group to which the sender terminal belongs, so that the users of other terminals can view the image from the content of interest and how the object was clicked on the image from the message, superimposed on the content of interest.

In step 210, the server 103 receives the message 111, the information to identify the content 108, and target area selected 109 transmitted from terminal A 101. The server may or may not store the received message and information into the database 107. The server then sends the message and information transmitted from terminal A to all or a limited number of terminals in the chat client group to which the sender terminal A 101 belongs. The server maintains and manages the address information, the information to identify the content, and the target area selected that were obtained for each terminal that accessed the server in the step 201. Upon receiving a message and accompanying information from terminal A, the server looks for a group including the terminal A, obtains the addresses of the terminals forming the group, together with the terminal A, and sends the message and accompanying information to these terminals. The server may store multiple messages from a terminal and send them to the chat client terminals at a time as a bundle of messages. The server may manipulate information in a message such as adding advertising information, emphasizing a part of the message, replacing a part of the message by another part, etc. and then send it to the chat client terminals.

In steps 211 and 212, terminal A 101 and terminal B 102 each receive the information transmitted from the server 103, such as message, information to identify the content, and target area selected. Each terminal displays text, advertising information, a thumbnail image, etc. derived from the message. If the message does not include a thumbnail image, the terminal may reproduce and display an image including the appropriate object form the content of interest stored within it, based on the information to identify the content and target area selected it received or may create and display a thumbnail of the object image identified by the above information and target area. How to create a thumbnail image and display it on the terminal will be explained later.

In steps 213, 214, 215 and 216 that correspond to the steps 209, 210, 211, and 212 for terminal A, terminal B 102 sends the message and other information via the server to terminals in the chat client group including terminal A 101. The above descriptions of the steps 209, 211, and 212 apply to the steps 213, 215 and 216, wherein terminal B 102 replaces terminal A and vice versa. In the way described above, messages and information are exchanged via the server.

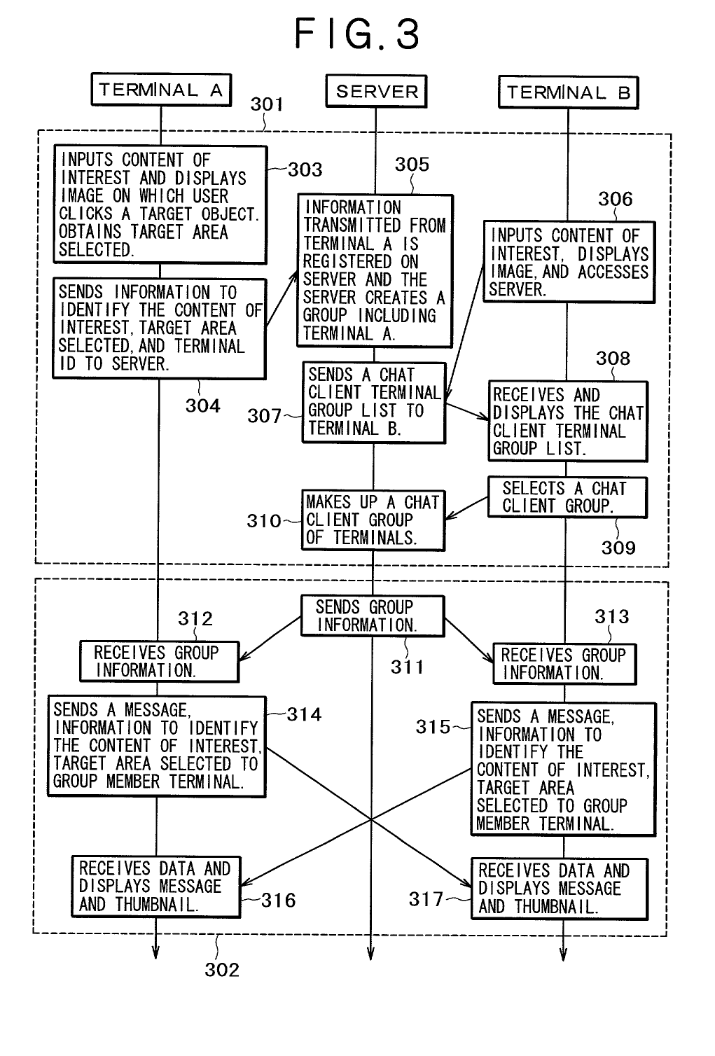

Using FIG. 3, another method of information exchange in accordance with another preferred embodiment of the present invention will be explained below. Step 301 is a process in which the server makes up a chat client group of terminals. Step 302 is a process in which the terminals exchange messages and information each other by the peer-to-peer communication. First, the step 301 will now be explained.

In step 303, content of interest rendered by media 105 is input to terminal A 101 and an image therefrom is reproduced and displayed. When the operating user of terminal A 101 takes interest in an object on the reproduced image, the user selects the position and area of the object within the image on the display screen, using the coordinates pointing device. Then, terminal A obtains the information to identify the content 108, target area selected 109, and its terminal identifier 110. This step corresponds to the step 203 in FIG. 2.

In step 304, terminal A 101 then sends the information to identify the content of interest 108, target area selected 109, and its terminal identifier 110 to the server 103. This step corresponds to the step 204 in FIG. 2.

In step 305, the server 103 receives the information to identify the content 108, target area selected 109, and terminal identifier 110 transmitted from terminal A 101 and registers them into the database 107. If, for example, a new object within an image displayed on the terminal A 101 is clicked and its information is registered on the server, a new group including terminal A 101 only is created.

In step 306, the same content of interest rendered by media as supplied to terminal A 101 is input to terminal B 102 and terminal B accesses the server. This means that the user of terminal B accesses the server, while watching the content rendered by TV broadcasting. While terminal B accesses the server in this embodiment, it is also possible to register the address of terminal B on the server beforehand, thereby enabling the server to access the terminal B.

In step 307, the server sends a chat client group list of the currently registered terminals to terminal B 102. The group list contains information generated each time the server creates a chat client group including the terminal(s) that accessed the server in the step 305 (that information will be referred to as group information hereinafter). The group information includes the information to identify the content of interest and target area selected. The group information may include other information such as the name of each group, group-associated thumbnail image, the addresses of chat client terminals belonging to the group, and the time when the latest chat message was issued to the terminals in the group. For the illustrative case of FIG. 3, the group information initially includes the information for a group (group 2) to which only the terminal A 101 belongs. For this group, the information to identify the content 108 and target area selected 109 transmitted from terminal A are registered. A plurality of groups may be registered into a group list. Each time a new object is clicked within an image displayed on a terminal and its information is sent to the server, the server adds a group to the list and sends the updated group list to all or a limited number of the terminals that have the access to the server. To make sure whether a terminal has the access to the server, any known method of verifying access may be used; for example, by measuring time after the terminal gains the access to the server or checking a logout request from the terminal.

In step 308, terminal B then receives and displays the group list transmitted from the server. In the illustrative case of FIG. 3, group information on group 2 including terminal A with the information to identify the content 108 and target area selected 109 transmitted from terminal A is registered in the list. By referring to the chat candidate group information, terminal B 102 then reproduces and displays an image including the appropriate object from the content of interest stored within it, based on the information to identify the content and target area selected, registered with the group information in the list. Alternatively, the terminal may create and display a thumbnail of the image including the appropriate object. If such thumbnail image is recorded with the group information in the list, it may be displayed. For displaying the list, known methods such as using a list structure or tree structure may be used.

In step 309, the user of terminal B then selects a chat client group that the user wants to have a chat with from the displayed group list and sends the selected group information to the server. In this example, terminal B selects group 2 including terminal A and sends it to the server as the selected group information. Through the steps 308 and 309, what visual object about which the terminal user that is accessing the server wants to have a chat with other clients can be known by the users of other terminals. Consequently, a chat session about the common subject of conversation can be initiated across the chat client users in an easy and intuitive manner.

In step 310, the server makes up a chat client group again, based on the selected group information it received. In this example, because group 2 including terminal A 101 was selected by the user of terminal B 102, the server adds terminal B 102 to group 2, then group 2 includes terminal A 101 and terminal B 102. Consequently, a chat session between terminal A 101 and terminal B 102 can be initiated. Terminal B 102 can exchange information with terminal A 101 with the image on which the target object was clicked on the terminal A 101 being shared by both terminals.

In the above-described step 301, terminal A 101 and terminal B 102 can thus be grouped together. The number of terminals to be grouped together is not limited to two; three or more terminals may be grouped together.

Then, step 302 in which the terminals grouped together exchange chat messages each other through a chat session will be explained. Step 302 represents a manner in which chat messages are exchanged by peer-to-peer communication.

In step 311, the server sends group 2 information to terminal A and terminal B that are the members of the group 2.

In steps 312 and 313, terminal A 101 and terminal B 102 which are the members of the group 2 receive the group information, respectively.

In steps 314 and 315, terminal A 101 and terminal B 102 respectively send a message, the information to identify the content, and target area selected to the other member of the group 2. This is equivalent to text exchange through a chat session. Because both terminals have already obtained the address of each terminal in the same group in the steps 312 and 313, they can exchange messages 118 each other without the intervention of the server.

In this way, message exchange by peer-to-peer communication can be performed. Messages to be exchanged are as described above. The information to identify the content and target area selected can be used when terminal users want to add visual information related to the messages. When the user of terminal A 101 and the user of terminal B 102 of group 2 are chatting with each other about the object that was initially clicked at terminal A, images rendered by TV broadcast are changing. For example, either user may want to capture a new image and select a new object to be shared across chat clients while letting the chat go on. When the user does so, terminal A or terminal B transmits the information to identify the new content of interest and the target area selected for the new object. Based on this information, by generating a thumbnail image including the new object at both terminals, both terminal users can continue the chat, viewing the common image of the new object.

In steps 316 and 317, terminal A and terminal B respectively receive and display the message, information to identify the content, and target area selected transmitted from the other terminal. At this time, each terminal may display the information it transmitted to the other terminal as well. In the way described above, messages and information are exchanged by the peer-to-peer communication, wherein it is possible to use any known method of peer-to-peer communication.

While the information exchange method by the combination of the steps 201 and 202 in FIG. 2 and such method by the combination of the steps 301 and 302 in FIG. 3 have been described, other combinations are possible. Another manner of information exchange is made possible by combining step 201 and step 302 or step 301 and step 202. Another process of grouping terminals built by appropriately combining step 201 and step 301 and another process of chat communication built by appropriately combining step 202 and step 302 may be used.

By operating the server in a manner allowing for charging that will be described below, services using the server for which a fee is charged can be realized. For example, charging is arranged for a service allowing two or more terminals to communicate the information to identify the content, target area selected, and messages one another via the computer network. When an end user enters a contract with the service provider or uses the service, the user should be charged a fee. Alternatively, when the server makes up a chat client group of terminals that accessed the server, the users of the terminals may be charged a fee. In another conceivable service, a terminal user appoints the identifier of a specific terminal of another user beforehand and the server notifies the terminal user that the specific terminal has accessed the server by some means such as e-mail. When the user enters a contract with the service provider for this service or uses the service, the user may be charged a fee. This service enables the user to chat with his or her friend, while viewing a TV program, when the friend begins to watch the TV, using the system. A service subscription fee or service use fee may be set differently for sending private chat messages to only a terminal whose identifier has been appointed beforehand and sending open chat messages to all terminals. The user may be charged a fee when a password exclusively for the user of the terminal whose identifier has been appointed beforehand is issued. It is convenient that the user's terminal address, user information, etc. be registered in advance when using this service. After contracting with the service provider, when the user registers the above information on the server, the user may be charged a fee.

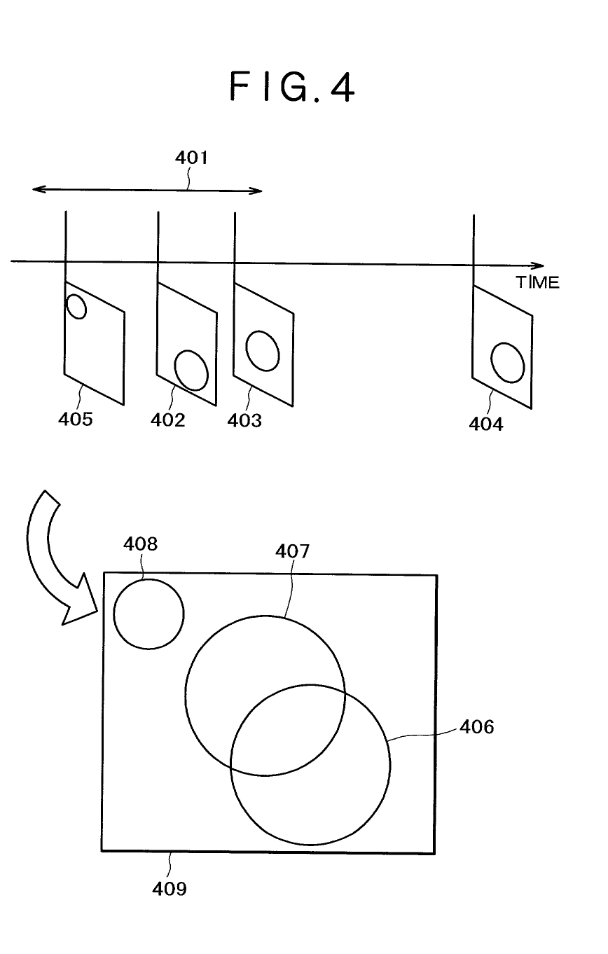

Using FIG. 4, methods of making up a chat client group of a plurality of terminals by comparing registered information specifics will be explained below.

Possible methods of making up a chat client group of a plurality of terminals include the following: grouping terminals, according to matching to a certain extent regarding the target area selected besides the matched information to identify the content of interest; grouping terminals by limiting the number of terminals to form a group to a given number; and grouping terminals, based on information such as appointed terminal identifiers, geographical area, interests, content titles, and community.

First, the method of grouping terminals, according to matching to a certain extent regarding the target area selected besides the matched information to identify the content of interest will now be explained. For example, assume that there are four terminals A, B, C, and D and same content of interest rendered by media is input to these terminals. Specifically, it is assumed that the users of these terminals were watching the same TV broadcast program broadcasted over a same channel in same area. Suppose that the users of terminals A, B, C, and D clicked target area on an image displayed on the terminals at different times, as represented by frames 402, 403, 404, and 405 shown in FIG. 4. A certain time range 401 is set beforehand. Terminals on which clicking target area occurs within the time range are picked up as those that may be grouped. Because the frame of terminal C falls outside the time range, terminal C is set apart. A scene change frame from the content of interest is detected by the server or the terminals. Even for the frames that fall within the time range 401, some of the frames before the scene change frame and other frames after the scene change are judged to be placed in different groups and may be set apart. Then, the remaining frames are put together 409 on a common plane viewed in the time direction to judge positional matching of each area selected on each frame. The area 406 selected on the frame of terminal A overlaps with the area 407 selected on the frame of terminal B. However, the area 408 selected on the frame of terminal D does not overlap with any other area, and therefore terminal D is set apart. In this example, terminal A and terminal B are judged to be grouped and terminals C and D are set apart. The degree of area overlap by which matching is judged is not definite. Terminals may be judged to be grouped if selected areas on their frames overlap at least in part or only if the proportion of the overlap to non-overlapped portions is greater than a certain value. Not only one frame is always captured on each terminal and not only one area is always selected on one frame. On each terminal, a plurality of frames may be captured and a plurality of areas may be selected at a time. By making up a chat client group of terminals for which matching to a certain extent regarding the target area selected has been verified in this way as well as the matched information to identify the content of interest, the users of the terminals can chat with each other, viewing the same object. As the method of grouping terminals by limiting the number of terminals to form a group to a given number, such a method is conceivable that terminals are grouped in the sequence in which they have accessed the server up to a specified number of terminals; when exceeding the number, another grouping starts.

Grouping terminals, based on information such as appointed terminal identifiers, geographical area, interests, content titles, and community is possible in several ways. For example, as terminals access the server, the server makes up a chat client group of terminals so that only the terminals with the appointed identifiers may join the group. Alternatively, a password required to join a group may be issued. Using the geographical area information, the server can make up a group of terminals that accessed the server from within a certain area. If it can be determined that terminal users who live even in different broadcast areas watch the same TV program from TV program scheduling information or the like, the broad channel numbers in the information to identify the content received from the terminals may be converted to a common one in the server. Things in which end users take interest may be registered beforehand as interest information. Consequently, the server can make up a chat client group of terminals whose users take interest in the same thing. If content of interest rendered by media is the one available in a package medium, it is preferable to obtain content title information such as the bar code or identifier of the package medium. Thereby, the server can make up a chat client group of terminals whose users have content of the same title or genre. It is useful to obtain user-identifiable information such as his or her address or name as community information, so that the server can make up a chat client group of terminals whose users belong to the same community. By additionally using such a diversity of auxiliary information as recited above, grouping terminals that is more effective is possible.

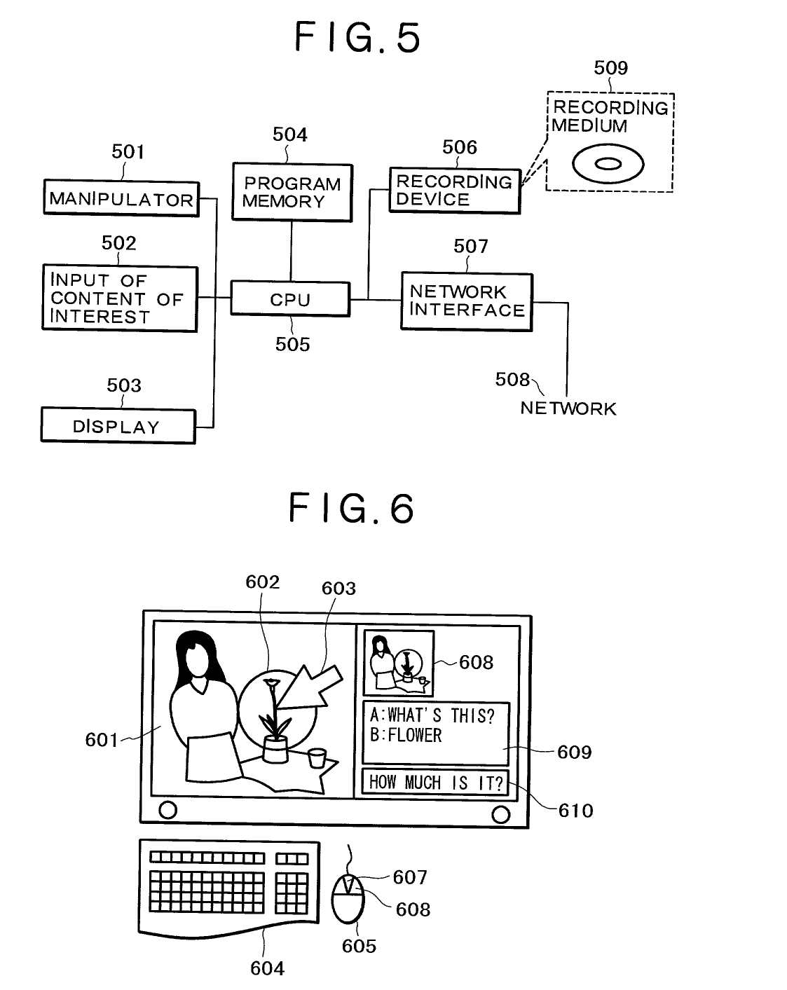

FIG. 5 shows the configuration of a terminal used in the present invention. Based on the instructions of a software program comprising the above-described steps, stored in a program memory 504, CPU 505 controls the overall operation of the terminal device. Content of interest rendered by media 105 supplied through the input of content of interest 502 is encoded so that it can be handled as digital data under the CPU 505. As the input of content of interest, a general TV tuner, a TV tuner board for personal computers, etc. may be used. For this encoding, methods in compliance with the ISO/IEC standards, such as Moving Picture Experts Group (MPEG) and Joint Photographic Experts Group (JPEG), and other commonly known methods are applicable, and thus a drawing thereof is not shown. During encoding, not only video signals, but also audio signals may be encoded in the same way. Encoded signals are decoded by CPU 505 so that content is reproduced and presented on the display 503. Separately from the CPU 505, an encoder and a decoder may be provided. Output to be made on the display 503 is not only the output of content reproduced by decoding encoded video/audio signals, but also the output of HTML documents or the like for displaying character strings and symbols of chat messages, thumbnail images, and reference information. In view hereof, the display may be configured with a first display for outputting content reproduced from decoded video/audio signals and a second display for outputting HTML documents or the like for displaying character strings and symbols of chat messages, thumbnail images, and reference information. As the first display, a TV receiver's screen may be used; as the second display, the display of a mobile terminal (such as a mobile telephone) may be used. The encoded signals may be once recorded by a recording device 506 so that content is reproduced after a certain time interval (time shift). As a recording medium 509 on which the recording device records the signals, a disc-form medium (for example, a compact disc (CD), digital versatile disc (DVD), magneto-optical (MO) disc, floppy disc (FD), hard disc (HD), etc.) may be used. In addition, a tape-form medium (such as videocassette tape) and a solid-state memory (such as RAM (Random Access Memory) and a flash memory) may be used. For time shifting, time-shifting methods that are now generally used are applicable. Because time shifting does not relate to the essence of the present invention, a drawing thereof is not shown. As for the input of content of interest and the display, the corresponding functions of other devices can be used instead of them (that is, they can be provided as attachments); they may be excluded from the configuration of the terminal. The input of content of interest 502 may operate such that it simply allows the terminal to obtain information to identify the content 108 and target area selected 109, but does not supply the content itself rendered by media 105 to the CPU 505. A manipulator 501 allows the user to define the target position (horizontal and vertical positions in pixels) and the target area (within a radius from the target position) on the display 503 on which an image in which the user takes interest is shown, based on the data from the above-mentioned pointing device. The manipulator 501 also allows the user to enter chat messages (using the keyboard or by selecting a desired one from a list presented).

Following the instructions of the program stored in the program memory 504, the CPU 505 derives the information to identify the content of interest rendered by media (channel over which and time when the content was broadcasted, receiving area, etc.) from the content supplied from the input of content of interest 502 and keeps it in storage. If time shifting is applied, the CPU makes the above information recorded with the content when the recording device records the video/audio signals of the content. The CPU reads the above information when the content is reproduced. Based on the information supplied from the input of content of interest, manipulator, and network interface, the CPU generates information to identify the content, target area selected, address information, messages, etc. and makes the network interface 507 transmit the generated information via the network 508 to the server 103. The network interface 507 provides the functions of transmitting and receiving commands and data over the network 508. Because the network interface can be embodied by using a network interface board or the like for general PCs, a drawing thereof is not shown. These functions can be implemented under the control of software installed on a PC or the like provided with a TV tuner function. In another mode of implementation, it is possible to configure a TV receiver or the like to have these functions.

It is preferable that the terminal has a thumbnail image generating function. The thumbnail image generating function gets the input of content of interest received or retrieved from the recording medium, information to identify the content, and target area selected, extracts a frame of content coincident with the time information, superposes the selected area on the frame, outputs a thumbnail of the image of the frame. This process will be detailed later. The information to identify the content and target area selected may be those received over the network or those obtained at the local terminal. Providing each terminal with this thumbnail image generating function makes it possible that the terminals in remote locations share a same thumbnail image by transmitting the information to identify the content and target area selected therebetween; the thumbnail image itself is not transmitted via the network.

FIG. 6 illustrates an example of displaying content on the display of a terminal used in the present invention. In this example, when user A 101 and user B 102 are in a chat session as they watch a same TV program, visual content and chat messages displayed on each terminal are illustrated. On the display screen 601, content of interest rendered by (TV broadcast) is displayed. Now, user A operating the terminal selects area 602 of an object in which the user takes interest by defining the area, using a pointer 603. User A controls the position of the pointer 603, using a mouse 605. Using the mouse wheel 607, the user can enlarge and reduce the circle of area selected 602 and fixes the area selected by actuating the mouse button 606. When selecting area, the user may define a circle as shown or any other shape such as a rectangle. When the area selected has been fixed by the user, a thumbnail image 608 is displayed as small representation of the image from the content of interest on which the object area has been selected and fixed. A thumbnail image may be generated on the local terminal or generated on another terminal, transmitted over the network to the local terminal, and then displayed. Alternatively, a thumbnail image may be generated from the information to identify the content, the target area selected, and the content of interest rendered by media stored in the recording device/medium of the local terminal as will be explained later. The user enters text or the like, using the keyboard 604 and chats with another terminal's user through a chat session. Entered text or the like is displayed in the message input area 610. Along with directly entering characters by the keyboard, it is also possible to select characters one by one from a list of characters and symbols prepared beforehand or select a sentence from a list of sentences prepared beforehand. Chat messages received from a chat user at another terminal are displayed in the display area for chat 609. Accompanying information such as user name, mail address, and time when the chat message was issued may be displayed. Accompanying information may be transmitted once in the first chat message and stored into the terminal that received it or the server, so that it is displayed with the first message and, subsequently, retrieved and displayed when another message is received from the same sender, or may be transmitted and displayed each time of chat message input. A thumbnail image may be displayed for each chat message shown in the display area for chat. If a great number of chat messages are to be shown in the display area for chat, a scrolling mechanism may be used to scroll display pages.

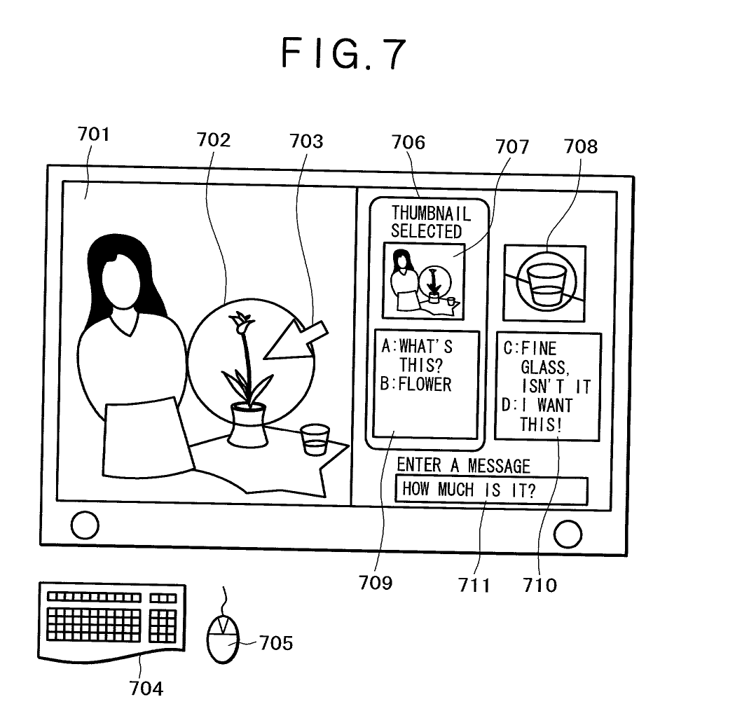

FIG. 7 illustrates another example of displaying content on the display of a terminal used in the present invention, wherein four users A, B, C, and D are in a chat session. The terminal is assumed operated by user A. The display screen 701, area selected 702, pointer 703, keyboard 704, and mouse 705 are the same as described for FIG. 6. A plurality of thumbnail images 707, 708 are displayed and the screen has a plurality of display areas for chat 709, 710. A select pointer 706 allows the user to view a plurality of chat messages and write some impression. User A selects area 702 of an object in which the user takes interest (for example, a flower in a vase) on the image displayed and exchanges messages with user B through the chat session. Now, the select pointer 706 of the terminal of user A points at the left (that is, chat with user B) and the thumbnail image 707 of the image for which user A is chatting with user B is displayed.

A message entered in the message input area 711 is shown in-the display area for chat 709. On the other hand, user C and user D are chatting about the thumbnail image 708 and their chat messages are shown in the display area for chat 710. All users in the chat session can refer the chat messages exchanged between user A and user B and the chat messages exchanged between user C and user D from their terminals. If user A wants to join in the chat between user C and user D, user A handles the select pointer 706 to point at the right and enters a message, thereby user A can join in the chat. The chat messages exchanged between or across chat users grouped by any of the above-described methods of grouping terminals can be shown and selection can be made among multiple chat client groups. In another possible mode of chat message display, only the selected thumbnail image and associated messages are shown in the display area for chat and other thumbnail images and associated chat messages are shown in a list from which the user can select the desired one to recall.

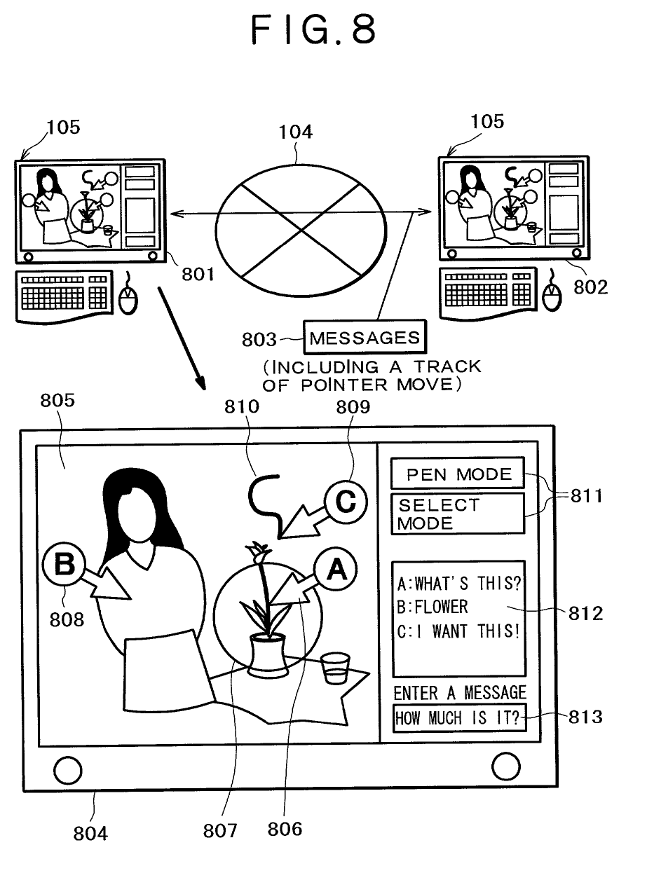

FIG. 8 illustrates an example of displaying content on the display of a terminal used in the present invention, according to a second preferred embodiment. In the example of FIG. 8, after the server makes up a chat client group of terminal A 801, terminal B 802, and terminal C (not shown) messages about an image displayed from the same content of interest rendered by media 105 are directly exchanged across the terminals via the network 104 by peer-to-peer communication. Display on screen 804 is an example of displaying an image from the content and related chat messages on terminal A 801. On the display screen 805, the pointers 806, 808, and 809 of terminals A, B, and C across which a chat session is going on are shown at the same time. The track of move of each pointer is included in the messages as track information and transmitted to other terminals in real time. When the user at terminal A moves the pointer 806, its move is reflected on the images shown at terminals B and C, and the pointer 806 of terminal A will move on the images shown at all terminals. Each user may feel as if three users sat in a room and were watching the same image on TV. Track information may be transmitted to other terminals each time the pointer moves or may be stored and transmitted at proper time intervals. The display may include a function of switching between the display of area selected 807 and the display of pointer track 810, using the mode selection button 811. In the display mode of area selected, when area has been selected and the selected area shown at terminal A, the information to identify the content, time or time range, and target area selected are transmitted to other terminals so that the area selected can be shown at other terminals. In the track display mode, tracks are transmitted to other terminals and shown there. Chat text information may be superimposed on the image on the screen. A thumbnail image display is used as well, the above-described method of displaying thumbnail images may be used. The display area for chat 812 and the message input area 813 are the same as described above. In the method of peer-to-peer communication of this embodiment, by the real-time operation of the mouse, audio data and visual data captured by a camera can be transmitted through a chat session, besides text transmission.

In the above example, after the server makes up a group of terminals, chat messages and other information are communicated across the terminals. If a terminal user knows beforehand the address of a peer that the user wants to have a chat with, the invention realizes information exchange without the intervention of the server.

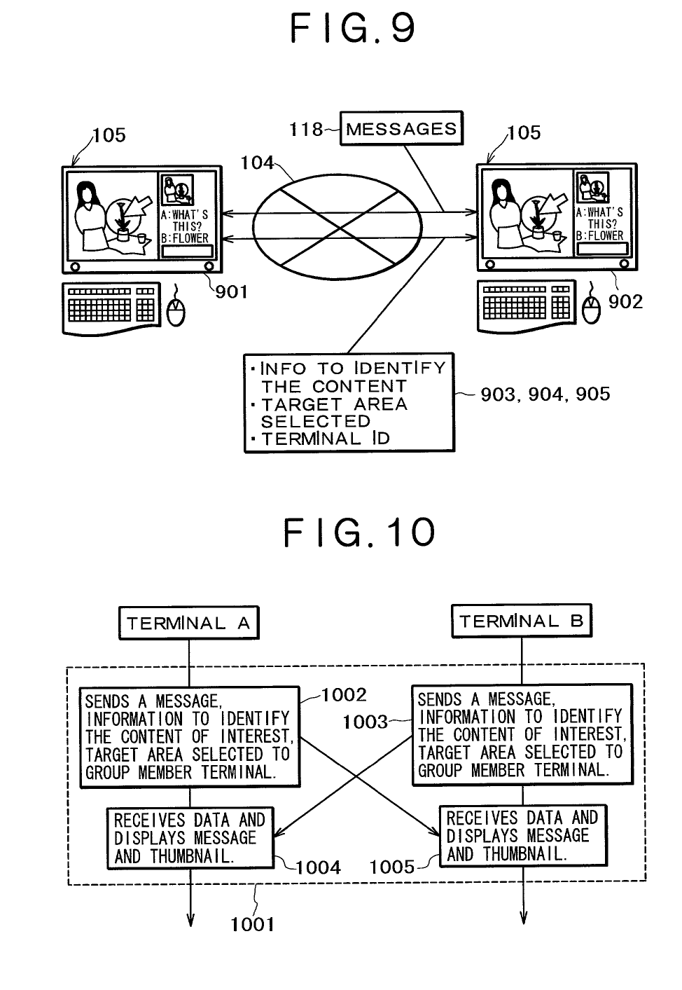

FIG. 9 is a conceptual drawing of a further preferred embodiment of the present invention, wherein terminal A 901 and terminal B 902 are in a session via the network 104. Initially, same content of interest rendered by media 105 is input to terminals A and B. According to the above-described method, terminal A 901 transmits information to identify the content 903, target area selected 904, and its terminal identifier 905 to terminal B 902, and vice versa. After a common thumbnail image of the same object is shown at both terminals, chat messages 118 are communicated therebetween.

Using FIG. 10, an information exchange method in accordance with the above further preferred embodiment of the present invention will be now explained. Step 1001 is a process in which terminal A 901 and terminal B 902 exchange messages each other through the peer-to-peer communication.

In steps 1002, 1003, terminal A and terminal B first send a message, information to identify the content, and target area selected to the other member of group 2, respectively. This corresponds to text exchange through a chat session.

In steps 1004, 1005, terminal A and terminal B receive and display the message, information to identify the content, and target area selected transmitted from the other terminal, respectively. At this time, on each terminal, the message(s) sent from that terminal may be displayed together with the received message(s). In this way, messages are exchanged by peer-to-peer communication.

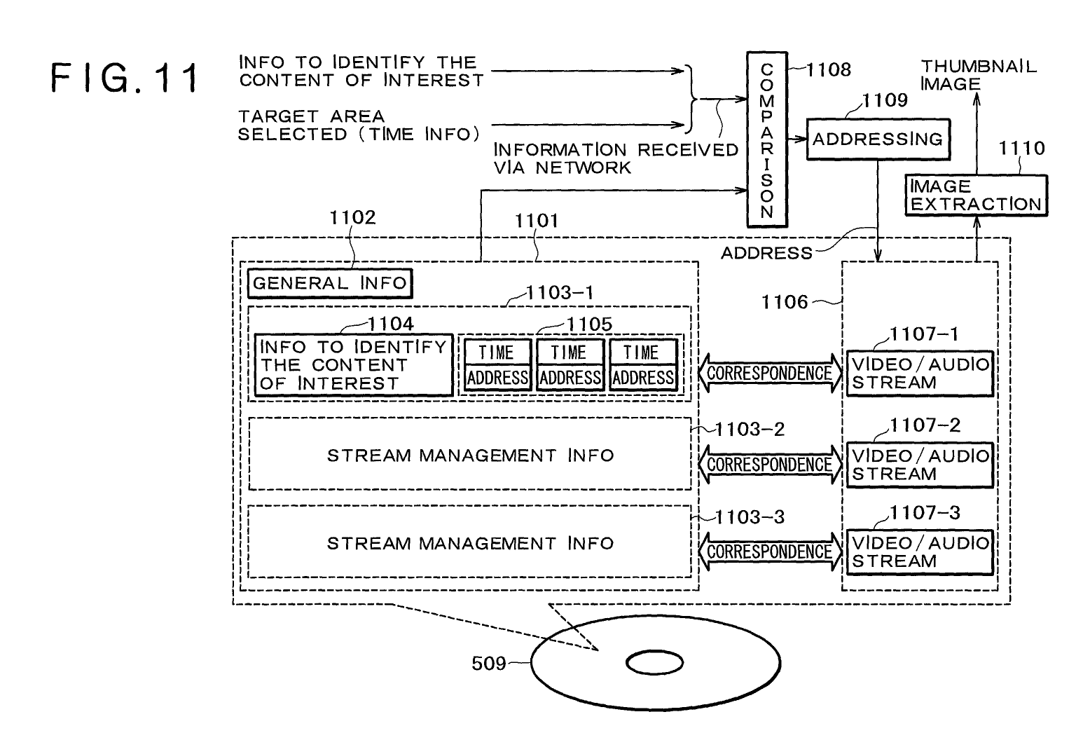

FIG. 11 is a conceptual drawing of exemplary thumbnail generating means in the present invention. First, information recorded on the above-mentioned recording medium for time shifting is roughly divided into content management information 1101 and content 1106. The content management information 1101 consists of general information 1102 that contains the number of items of stream management information 1103 and relations and stream management information 1103 (by way of example, consisting of three items 1103-1, 1103-2, and 1103-3). The content 1106 consists of vide/audio streams 1107 (by way of example, three streams 1107-1, 1107-2, and 1107-3) of encoded content of interest rendered by media. There is correspondence between one item of stream management information 1103 and one video/audio stream 1107 and a plurality of pairs thereof usually exist. Each item of stream management information 1103 consists of information to identify the content of interest 1104 and an address map 1105. The address map 1105 is a table of mapping between a time stamp during the time when the content was broadcasted and the address of a record within the associated video/audio stream 1107. Time-to-address mapping data is added to this table at given intervals (for example, at the end of every frame).

Using the configuration shown in FIG. 11, a terminal can generate a thumbnail image, based on the information received via the network. A comparison unit 1108 first compares received information to identify the content 108, 112, or 903 and the information to identify the content of interest 1104 recorded on the recording medium 509. The comparison unit then compares time information that accompanies received target area selected 109, 113, or 904, that is, time when the object was clicked, with the time stamps in the address map 1105 recorded on the recording medium 509. Then, an addressing unit 1109 finds out the address of the record in the video/audio stream 1107 matching with the received time information. Based on this address, an image extraction unit 1110 extracts the image record from the video/audio stream 1107 and generates a thumbnail image from the record. At this time, the image may be reduced as required.

Using the configuration shown in FIG. 11, based on information received via the network, a terminal can reproduce images with sound from a video/audio stream identified by the information. In the same way as described above, the comparison unit 1108 compares received information to identify the content 108, 112, or 903 and the information to identify the content of interest 1104 recorded on the recording medium 509. The comparison unit then compares time information that accompanies received target area selected 109, 113, or 904 with the time stamps in the address map 1105 recorded on the recording medium 509. Then, the addressing unit 1109 finds out the address of the record in the video/audio stream 1107 matching with the received time information. From the video/audio stream 1107 starting from this address, the object images with sound can be reproduced. In this way, image reproduction in accordance with the information received via the network can be implemented.

Using the above configuration, it is also possible to map a thumbnail image (that is, output from the image extraction unit 1110) to the address of the record from which the thumbnail image was generated (that is, output from the addressing unit 1109) for thumbnail management. In consequence, when the user selects a thumbnail image, reproduction from the image/audio stream associated with the thumbnail takes place.

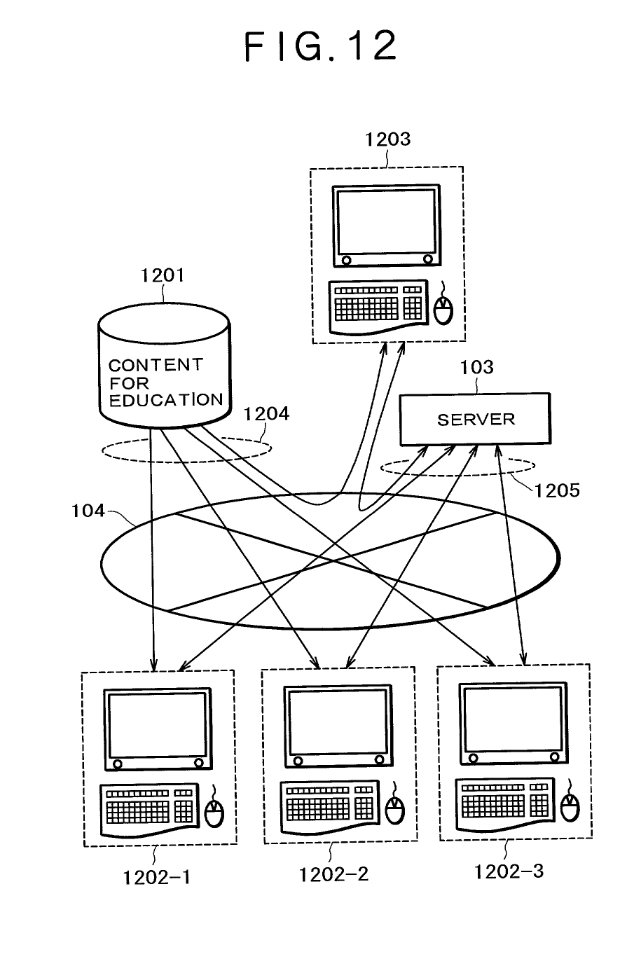

FIG. 12 is a conceptual drawing of a further preferred embodiment in which the present invention is applied to an education system. In this embodiment shown in FIG. 12, content for education 1201 is transmitted to terminals for students 1201 (by way of example, three terminals 1201-1, 1202-2, and 1202-3) and a terminal for tutor 1203. The flow of content distribution 1204 is unidirectional, wherein the content corresponds to content of interest rendered by media in the foregoing embodiments. The content may be distributed in streams over the network 103 as shown in FIG. 12 or by using TV broadcast or the like in the foregoing embodiments. As the terminals for students 1202 and the terminal for tutor 1203, the terminals 101 and 102 in the foregoing embodiments can be used. The terminals for students 1202 and the terminal for tutor 1203 are connected via the network 103 and the server 103 and the flow of questions and answers 1205 is bidirectional between the students and the tutor. Whether messages are exchanged between or across the terminals for students (for example, between terminals 1202-1 and 1202-2) depends on circumstances. In one possible manner, the server 103 selectively controls the destinations of messages. In another possible manner, message destination discriminative information is attached to messages so that the server will separate messages to be transmitted to the terminal for tutor 1203 and messages to be transmitted to other terminals for students, thereby performing selective transmission as above. The server 103 or the terminal for tutor 1203 may exercise concentrative management of message destination discriminative information.

The education system configured as shown in FIG. 12 makes it possible that students send question messages about the content for education 1201 to the tutor and the tutor returns answer messages to the students, wherein any existing content for education 1201 is used as is. Specifically, watching video content for education which is displayed on the display screen as shown in FIGS. 7 and 8, students specify a problem that is difficult to understand on the displayed image, using the pointer, and thereby can have a conversation with the tutor about the problem. This helps the students in understanding the subject better than learning by simply watching the video content for education. It is advisable to store question and answer messages into a database of the server, wherein the messages are linked with the content for education 1201 by the information to identify the content and target area selected. This is useful in that matters in which students are liable to have difficulty (that is, matters about which many question messages were issued) can be verified later and in providing other students and system administrators with reference information when other students learn by replaying the same content for education 1201 at another opportunity or when the content for education 1201 is updated. Not limited to education, application of the present invention has a wide range including, for example, a guidance system of cooking classes and a user manual system of articles of trade.

The above-described embodiments discussed illustrative cases where the content of interest is rendered by general TV broadcasting using transmission media such as terrestrial broadcasting, broadcasting satellites, communications satellites, and cables. The present invention is not limited to these embodiments. In this invention, information (data) that is rendered in various modes is applicable, including motion and still video contents which are distributed over networks such as the Internet, motion and still video data for which where the content of interest is stored is made definite by the information to identity the content, for example, the address of a general Web site/page on the Internet, and so on. With regard to the information for area selected with a time range for a sequence of frames, which is communicated between the terminals and the server, if only the time range is used, content of interest rendered by media can be audio information not including video. The present invention can also be applied to audio information distributed by radio broadcasting and over a network in the same way. As the computer network used, an intranet (organization's internal network), extranet (network across organizations), leased communication lines, stationary telephone lines, cellular and mobile communication lines, etc. may be used, besides the Internet. As the content of interest rendered by media, content recorded on recording medium such as CD and DVD can be used. While, in the above-described illustrative cases, HTML documents are used to display character strings and symbols of chat messages, thumbnail images, and reference information, other types of documents are applicable in the present invention; for example, compact-HTML (C-HTML) documents used for mobile telephone terminals and text documents if the information to be displayed contains character strings only.

By applying the present invention whereby visual information and messages are linked up, the following is enabled. When watching a TV program or the like, a plurality of terminal users in remote locations, simultaneously watching a visual object displayed on the TV receiver screen, easily exchange information related to the visual object by exchanging messages through chat sessions.

While the present invention has been described above in conjunction with the preferred embodiments, one of ordinary skill in the art would be enabled by this disclosure to make various modifications to this embodiment and still be within the scope and spirit of the invention as defined in the appended claims.

What is claimed is:

1. An information exchange method in which:
two or more terminal devices for information exchange connected to a computer network obtain content of interest rendered by media;
first and second terminal devices for information exchange send information to identify the content and target area selected to define a part or all of an object from the content to the other terminal device, respectively, across the computer network; and
based on the information to identify the content and target area selected received, the first and second terminal devices send/receive messages to/from the other terminal device.

2. An information exchange method as recited in claim 1 wherein:
said first terminal device for information exchange receives or retrieves content of interest rendered by media and sends first information to identify the content and first target area selected to define a part or all of an object from the content to an information exchange server equipment across the computer network;
said second terminal device for information exchange receives or retrieves content of interest rendered by media and sends second information to identify the content and second target area selected to define a part or all of an object from the content to the information exchange server equipment across the computer network;
the information exchange server equipment makes up a group of said first and second terminal devices for information exchange, according to a grouping method using said first and second information to identify the content and said first and second area selected that it received;
the first terminal device for information exchange sends a first message to said information exchange server equipment across the computer network;
said information exchange server equipment sends said first message that it received to one or more terminal devices for information exchange belonging to said group and including said second terminal device for information exchange across the computer network; and
said second terminal device for information exchange receives and outputs said message.

3. An information exchange method as recited in claim 2 wherein:
said grouping method comprises one of or a combination of a plurality of the following:
grouping terminal devices for information exchange for which matching to a certain extent occurs regarding said information to identify the content received therefrom;
grouping terminal devices for information exchange for which matching to a certain extent occurs regarding said information to identify the content and said target area selected, received therefrom;
grouping terminal devices for information exchange by limiting the number of terminal devices to form a group to a given number;
grouping terminal devices for information exchange for which matching occurs in one of or a plurality of items of information designating appointed identifiers of terminal devices for information exchange, geographical area, interests, content titles, and community, respectively.

4. An information exchange method in which:
an information exchange server equipment makes up a group of two or more terminal devices including first terminal device for information exchange and second terminal device for information exchange;
said first terminal device for information exchange obtains content of interest rendered by media and sends information to identify the content, target area selected to define a part or all of an object from the content, and a message to said information exchange server equipment across a computer network;
said information exchange server equipment sends said information to identify the content, said target area selected, and said message that it received to one or more terminal devices for information exchange belonging to said group and including said second terminal device for information exchange across the computer network; and
said second terminal device for information exchange receives and records or retrieves content of interest rendered by media, outputs said information to identify the content that it received and a frame from the content including the object defined by said target area selected, and outputs said message that it received.

5. An information exchange method as recited in claim 4 wherein:
said information exchange server equipment makes up a group of terminal devices for information exchange having a group identifier registered beforehand.

6. An information exchange method as recited in claim 4 wherein:
said information exchange server equipment makes up a group of terminal devices for information exchange in such a way in which:
said server equipment makes a list of one or more groups that have been made up and related information (which will be referred as group-information hereinafter) and sends the group list to the first terminal device for information exchange across the computer network;
said first terminal device for information exchange receives and outputs the group list, selects the group information for one group from the group list, and sends the selected group information to the server equipment across the computer network; and
the server equipment sets the first terminal device joined the group appointed by the selected group information.

7. An information exchange method as recited in claim 6 wherein:
said group information includes said information to identify the content and said target area selected.

8. An information exchange method as recited in claim 4 wherein:
said message comprises one of or a combination of a plurality of the following items: character strings of text and keywords, audio information, video information, advertising information, time information, thumbnail images, and pointer information.

9. A terminal device for information exchange comprising means for inputting and displaying content of interest rendered by media; means for obtaining information to identify the content; means for obtaining target area selected to define a part or all of an object from the content; means for inputting messages; and means for transmitting and receiving said information to identify the content, said target area selected, and messages over a computer network.

10. A terminal device for information exchange as recited in claim 9 further comprising means for storing said content of interest; and means for generating and displaying a thumbnail image from said information to identify the content, said target area selected, and said content of interest stored.

11. A terminal device for information exchange as recited in claim 9 further comprising time shifting means for recording and reproducing said content of interest.
